(19) United States
(12) Patent Application Publication
(10) Pub. No.: US 2006/0045837 A1
(43) Pub. Date: Mar. 2, 2006

(54) Method and apparatus for heat treatment of powder of fine carbon fiber

(76) Inventor: Kunio Nishimura, Kanagawa (JP)

Correspondence Address: BIRCH STEWART KOLASCH & BIRCH, PO BOX 747, FALLS CHURCH, VA, 22040-0747, US

(21) Appl. No.: 10/532,970

(22) PCT Filed: Oct. 28, 2003
(86) PCT No.: PCT/JP03/13795

§ 371 Date: Apr. 27, 2005

(30) Foreign Application Priority Data
Oct. 28, 2002 (JP) 2002-313101

(51) Int. Cl. C01B 31/02; F23C 5/00

(52) U.S. Cl. 423/445 R; 431/8

(57) ABSTRACT

Provided are a powder heat treatment process, wherein fine carbon fibers are heated in a heating furnace at a temperature of 800° C. or higher under an inert gas atmosphere or a hydrogen gas atmosphere in the form of powder taken out from a reaction furnace for producing the fine carbon fibers or after compressing and crushing the fine carbon fibers to turn them into amorphous powder without filling them into a specific vessel or compaction-molding them to thereby vaporize volatile components stuck to the fibers and carbonize them at a higher temperature and powder heat treatment equipment, wherein a heating furnace part is partitioned by push-in plates for fine carbon fibers or stirring devices in the furnace; a surrounding gas-discharging port is provided in a part close to a fiber-charging port out of compartments partitioned by the above plates or devices; and a gas-feeding port is provided in a part close to an outlet for the above fibers.

### TECHNICAL FIELD

The present invention relates to a production process for a fine carbon fiber material which is excellent in characteristics such as electron emitting ability, hydrogen storage ability, electroconductivity and thermal conductivity and which is used for various secondary batteries including a Li ion battery, fuel cells, FED, superconductive devices, semiconductors and electroconductive composite materials and production equipment, more specifically to a heat treatment process for turning vapor grown carbon fibers produced by a CVD process under non-oxidative atmosphere, single-walled and multiwalled carbon nanotubes or mixtures of the above carbon nanotubes into products having a required quality and heat treatment equipment.

### BACKGROUND ART

A lot of unreacted organic compounds and polymers are sometimes contained as volatile tarry matters in so-called as-grown products taken out from a reaction furnace in the case of vapor grown carbon fibers and carbon nanotubes produced by a CVD process. It is known that the above as-grown carbon fibers and carbon nanotubes in which the unreacted organic compounds and polymers are adsorbed on surfaces cause troubles in a treating step when they are processed into composite materials and that they have inferior crystallinity so that heat treatment is required in order to remove volatile components to improve the crystallinity. In order to surely carbonize and crystallize the above fibers and nanotubes with the above tarry matters which are carbon components having a low boiling point or a high boiling point volatilizing, carried out is a two stage treatment process in which the above volatile components are burned in advance at a temperature of, for example, 1500° C. or lower and then heat treatment for carbonization and crystallization is carried out at 2000 to 3000° C. In these processes, however, the fibers or the nanotubes are filled into a vessel such as a crucible and a boat or compaction-molded and then subjected to heat treatment batchwise (Japanese Patent Application Laid-Open No. 021911/1985, Japanese Patent Application Laid-Open No. 133120/1987, Japanese Patent Application Laid-Open No. 191515/1987, Japanese Patent Application Laid-Open No. 006624/1990, Japanese Patent Application Laid-Open No. 101118/1994, Japanese Patent Application Laid-Open No. 212517/1994, Japanese Patent Application Laid-Open No. 025626/1998, Japanese Patent Application Laid-Open No. 312809/1998 and Japanese Patent Application Laid-Open No. 208145/2000).

Vapor grown carbon fibers and carbon nanotubes have a very small bulk density of 0.1 g/cm³ or less, and therefore heat treatment equipment having a very large volume is required in order to subject them to heat treatment in a large amount. Accordingly, the actual industrialization thereof requires an enormous cost of facilities and energy. Then, the actualization of a process which can industrially be operated requires increase in the bulk density and reduction in a size of the facilities, and therefore employed is a process in which the above fibers or nanotubes are filled into a vessel or are compaction-molded and then subjected to heat treatment. However, the following problems are involved in those processes.

A) Problems in a Process in which they are Filled into a Vessel

1) The vessel is a graphite crucible, and a graphite crucible having a large volume is required for treatment in a large quantity, so that the cost therefor is increased.

2) If pressure is not applied when filling into the vessel, the amount to be filled is extremely small, and the efficiency is inferior.

3) When using a crucible, the bulk density is 150 kg/m³ or less at most even if applying pressure, and the weight of the product is very small as compared with the weight of the vessel.

4) Accordingly, a greater part of energy used is consumed for heating the vessel.

5) The filling device is large-scaled, and a cost for the device is required.

6) Taking the facility cost and the operation cost into consideration, the product is commercially expensive.

B) Problems in a Compaction-Molding Process

1) Even if compaction-molded, a bulk density of the molded article can not be larger than 150 kg/m³.

2) Even if compaction-molded, the volume is expanded due to elasticity of the fibers when releasing pressure applied.

3) It is difficult to apply even pressure to the inside of a fiber aggregate in a powder compressing operation, and molding is not easy.

4) The molded article has a low density and is expanded due to elasticity, and therefore the molded article does not have sufficient strength for operation. The expansion due to elasticity caused when releasing pressure applied to the compaction-molded powder brings about the collapse of the molded article to turn it into disordered amorphous powder which can not transmit force, and the fibers in this collapsed part bring about clogging in the furnace or in a transferring conduit of the molded article. In addition thereto, the smaller the fiber diameter is, the greater the expansion caused due to the elasticity after compacting the fibers is, and therefore the above clogging is more liable to be caused. Accordingly, troubles are liable to be caused in a step where fine carbon fibers are subjected to heat treatment.

However, it has so far been considered that in a process in which powder discharged from a reaction furnace is subjected as it is continuously or batchwise to heat treatment heat efficiency is low and heat treatment is unsufficiently carried out, and therefore it is not yet reported to carry out heat treatment by such a process.

As described above, in a process in which filling into a vessel or compaction-molding is carried out, complication in the equipment and increase in the equipment cost and the production cost brought about thereby make it difficult to carry out heat treatment commercially efficiently. An object of the present invention is to newly provide a process in which fine carbon fibers are subjected to heat treatment at a low cost in a large amount to allow crystallization thereof to proceed and equipment for the process.

### DISCLOSURE OF THE INVENTION

In the present invention, the fine carbon fibers mean fine fibrous carbon materials such as vapor grown carbon fibers (VGCF), carbon nanotubes, carbon nanocones, carbon nanocoils and ribbon-shaped carbon fibers.

The characteristics of carbon base fiber materials such as a vapor grown carbon fiber and a carbon nanotube are related closely to the crystallinity thereof. Earnest researches repeated by the present inventors have resulted in finding such knowledge contrary to a conventional common sense that a vapor grown carbon fiber and a carbon nanotube, to be surprised, not only have good heat conductivity but also rise in crystallinity for very short time. Accordingly, it has been found that sufficient heat treatment can be achieved by treating the powder as it is or treating the amorphous powder obtained by crushing the compressed powder and that use of such a process makes it possible to far more efficiently carry out crystallization, and thus the present invention has been completed.

Paying attentions to the very good heat conductivity of the above substances, the present invention has been developed and it provides a process in which the powder discharged from a reaction furnace is subjected as it is directly to heat treatment or the amorphous powder obtained by crushing the compressed powder is treated to crystallize it and equipment used for the process.

The present invention is characterized by:
1) a process in which fine carbon fibers are charged into a heating furnace in the form of powder to carry out heat treatment without filling them into a specific vessel or compaction-molding them, that is, a powder heat treatment process in which vapor grown carbon fibers, carbon nanotubes and the like are heated in the form of powder taken out from a reaction furnace at a temperature of 800° C. or higher under inert gas atmosphere or hydrogen gas atmosphere and equipment used for the process, or
2) a process in which fine carbon fibers are once compressed and then crushed to turn them into amorphous powder and in which they are then subjected to heat treatment at a temperature of 800° C. or higher under an inert gas atmosphere or a hydrogen gas atmosphere and equipment used for the process. The fine carbon fibers are subjected to heat treatment in the form of the powder having fluidity by the above processes of 1) or 2), and therefore the phenomenon of clogging of the equipment due to the collapse of the molded article subjected to heat treatment can be avoided.

Compressing and crushing in the present process are carried out before the heat treatment. The powder after crushing has a bulk density of preferably 15 to 35 kg/m³, more preferably 20 to 30 kg/m³.

Further, the present invention is characterized by the following.

3) A treatment temperature in the inside of the furnace is 800° C. or higher, and preferably carried out are (1) first stage heat treatment in which volatile components stuck to the fine carbon fibers are vaporized at a temperature of 800 to 1500° C. and (2) second stage heat treatment in which they are then carbonized at 1300 to 3000° C.

4) Inert gas such as argon, helium and xenon or hydrogen is used as a surrounding gas in the heat treatments to carry out the heat treatments under an inert or reducing atmosphere. It is possible to partially add a hydrocarbon gas. The surrounding gas may be allowed to flow in any direction. It is preferable to flow from a discharging port side of the powder to a charging port side thereof, and in the case of the second stage, it is allowed to flow preferably from a side which is gravitationally positioned at a lower part to a side which is positioned at an upper part.

5) An inflow port and a discharge port of the gas are preferably provided separately in parts close to a charge port and a discharge port of the powder.

6) The inside of the heating furnace may be partitioned by push-in plates or stirring devices, and a gas discharge pipe is provided in a part which is in the compartment closest to a raw material charging side and which is as hot as possible in the vicinity of a raw material charge port when partitioned by these plates or stirring devices and in the part described in above 5) when not partitioned, and preferably in a part of 1500° C. or higher. A trap for carried components such as the catalyst components, the fine carbon fiber powder and the like contained in a waste gas and a waste gas treatment apparatus for treating tar and the like are provided at a downstream side of the gas discharge part.

7) A gas storing tank in which gas can be stored is disposed before or after the discharge port of the carbon fiber powder in the heat treatment equipment, and this storing tank is connected to the heating furnace. A mechanism which can shut the storing tank is provided in the above connecting part. An inner pressure of the storing tank is raised higher than that of the heating furnace in shutting the storing tank, and pressure accumulated therein is released into the heating furnace by opening the shutting mechanism to send a pressure fluctuation wave into the heating furnace. The above accumulated pressure is enough if it is higher by 1 kPa or more than a pressure in the inside of the heating furnace, and it may be higher by 5 kPa or more, and further by 20 kPa or more. The pressure fluctuation wave is preferably transmitted intermittently, and the cycle thereof is preferably 10 to 120 seconds, more preferably 30 to 60 seconds.

An apparatus for transmitting a pressure fluctuation wave to the heating furnace may also be used as a push-out apparatus for sending the carbon fiber powder subjected to heat treatment from the above powder discharge port to the subsequent step, and in this case, a push-out plate becomes the shutting mechanism described above.

8) The heating furnace is a vertical furnace having an angle of 0° or more to 90° from a horizontal plane, and it is preferably perpendicularly disposed.

The heating furnace has a tube in which a cross-sectional form is circular, ellipsoidal, polygonal or rectangular, and a heating part is provided in the furnace. The heating method may be either of a method in which a furnace core tube is directly heated by a high-frequency wave and a method in which the furnace core tube is heated by means of a resistance heating device.

The fine carbon fibers are allowed to gravitationally fall in the above furnace, whereby they are continuously transported in the heating furnace.

9) Provided in the powder heat treatment equipment described above are a charging device for charging the fine carbon fibers to the heating furnace described above, a surrounding gas-feeding device for feeding an inert gas or a hydrogen gas to the heating furnace, a collecting device for collecting the fine carbon fibers from the heating furnace, a controlling device for controlling flow of the powder in the inside of the heating furnace and a trap for trapping carried components contained in a waste gas coming from the heating furnace.

According to the process of the present invention, a crucible or a molding apparatus by compaction-filling is not required, and therefore the equipment cost is markedly inexpensive as compared with those in conventional heat treatment process. Further, energy for heating a crucible is not required, and it can be expected to a large extent that the operating cost is reduced. In addition thereto, the equipment is simplified, so that troubles are reduced.

### BRIEF DESCRIPTION OF THE DRAWINGS

FIG. 1 is a schematic drawing of heat treatment equipment of a batch process used in Example 1.

FIG. 2 is a schematic drawing of heat treatment equipment of a continuous process used in Example 2.

FIG. 3 is a schematic drawing of heat treatment equipment of a semi-batch/continuous process used in Example 3.

FIG. 4 is a chart of differential thermal analysis of the fine carbon fibers before subjected to heat treatment in Example 2.

FIG. 5 is a chart of differential thermal analysis of the fine carbon fibers after subjected to heat treatment in Example 2.

### BEST MODE FOR CARRYING OUT THE INVENTION

The present invention can be carried out by any of three kinds of batch process, continuous process and semi-batch and/or continuous process.

Powder heat treatment equipment of a batch process is powder heat treatment equipment installed a tubular or cylindrical heating furnace placed at an optional constant angle between verticality and horizontality, wherein the above heating furnace is equipped with a push-in device driven by reciprocating motion for the fine carbon fibers subjected to heat treatment and a shutting plate. It is characterized by having a holding plate for preventing short-cut of a non-heated portion of the powder at the lower part and a push-in plate having a function of compressing and/or scratching off the powder at the upper part of the furnace. The above push-in plate and holding plate are driven alternatively or according to a fixed time schedule to subject the powder introduced from the upper part to heat treatment batchwise.

A powder heat treatment equipment in a continuous process is a powder heat treatment equipment installed a tubular or cylindrical heating furnace of a vertical type placed at an angle which is larger than 0 degree from a horizontal plane and which is sufficient for making it possible to allow the powder to flow by means of gravity, wherein the fine carbon fibers are continuously transferred in the above furnace with flowing by means of gravity.

The powder which is compressed and crushed is introduced into the furnace from the upper part and piled. Such powder is very excellent in an operating property in the point that it is not turned into disordered amorphous powder which can not transmit force. In this case, the above powder is not compressed and molded in the furnace because of a very small specific gravity and high elasticity. That is, in the heating furnace in the powder heat treatment equipment of the present invention, a pressure of the powder on the lowest face of the powder in the furnace is preferably 2 kPa or less, more preferably 1.5 kPa or less and most preferably 1.1 kPa or less. If the pressure falls in the above range, compressing and molding of the carbon fibers do not take place, and therefore clogging of the pipe caused by crushing thereof can effectively be prevented. For example, when the powder is piled 10 m high, a pressure on the lowest face of the powder is merely 0.294 kPa when the bulk density is 30 kg/m³, and it is merely about 1 kPa in the case of 100 kg/m³. According to Japanese Patent Application Laid-Open No. 60444/1996, it is described that a pressure required for molding the fine carbon fibers is 0.1 kg/cm² (=9.81 kPa) or more. Based on this, the pressure exemplified above which is brought about by an own weight of the powder is not sufficient for compressing the powder.

The powder subjected to heat treatment is discharged from the lower part of the heating furnace. The discharge mechanism at the lower part is a reciprocating type pushing-out device, and therefore a weak pressure fluctuation can be given to the inside of the heating furnace by feeding a gas to a connecting rod side of a piston when the powder are pushed out by a push-out plate.

A furnace core tube is preferably cylindrical. A caliber of the furnace core tube is preferably 1000 mmφ or less, more preferably 700 mmφ or less and most preferably 500 mmφ or less. If it falls in the above range, a heat transfer efficiency such that the carbon fibers moved by an own weight thereof are sufficiently heated can be obtained.

Powder heat treatment equipment of a semi-batch and/or continuous process is powder heat treatment equipment which is installed a lateral heating furnace disposed horizontally or almost horizontally and which is a tubular or cylindrical furnace having a circular, ellipsoidal, polygonal or rectangular cross-sectional form, wherein plural push-in plates which do not completely shut up the inner wall of the furnace are disposed on a driving shaft disposed so as to pass through the center of the furnace; the above driving shaft rotates and reciprocates in a horizontal direction; the furnace has a heating part in an inside thereof; and the fine carbon fibers are moved semi-batchwise or continuously. It is equipment in which the powder is pushed in and moved continuously and/or batchwise by charging the powder from a raw material-charging device continuously and/or batchwise and repeating rotation and reciprocation of the driving shaft capable of rotating and reciprocating and equipped with flat or curved push-in plates and in which the treated fibers are taken out from the lower part in a downstream. The form of the above push-in plates shall not be restricted as long as they are flat or curved and have a structure in which residence of the powder can be controlled, and they can be mounted as well at a fixed spacing and/or a fixed angle. Further, they can assume as well a structure in which the shaft is parallel vibrated or rotationally vibrated. This makes it possible to control a residence time of the powder and improve the heat transfer efficiency by bringing the powder into contact with the inner wall face of the furnace. When the treating temperature is 1500° C. or higher, the materials of the mechanical parts are preferably ceramic materials and graphite materials.

A method suited to the target temperature can be selected as a heating means for the heating furnace, and a method such as resistance heating and high-frequency heating can be employed. In the case of 2000° C. or higher, high-frequency heating is preferred. The material suited to the heating method can be selected, and a graphite material is preferred in the case of high-frequency heating.

### EXAMPLES

Next, the present invention shall be explained in further details with reference to examples, but the present invention shall by no means be restricted to the examples described below.

### Example 1

Batch Process Equipment

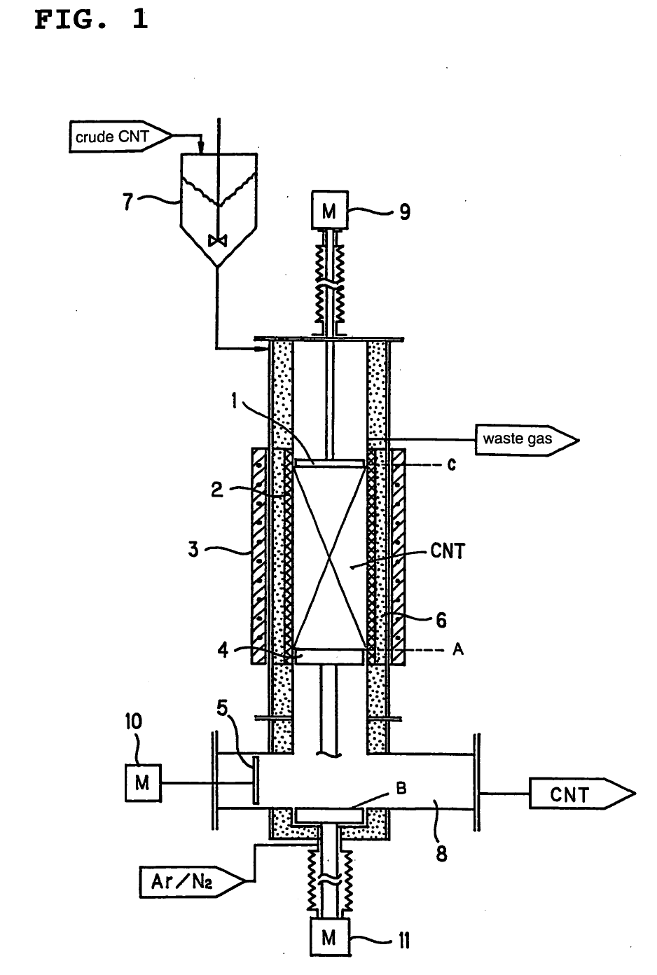

Carried out by equipment shown in FIG. 1.

It is a vertical batchwise heating furnace having an inner diameter of 200 mm, and it is equipped at an upper part with a charging device (7) for as-grown fine carbon fibers to be subjected to heat treatment and a driving mechanism (9) for moving upward and downward a push-in plate (1) for pushing in and scratching off the above material. A discharge port for a waste gas is disposed at an upper part of a heating part. Disposed at the lower part is a collecting mechanism comprising a collecting tank (8) for the above fine carbon fibers after subjected to heat treatment, a discharge plate (5) for the carbon fibers subjected to heat treatment and a driving mechanism (10) therefor and a holding plate (4) for preventing the untreated carbon material from leaking and a driving mechanism (11) therefor. The above holding plate is reciprocated alternatively between a position of an end A of a soaking part and a position of B in which a scratching operation is able to be carried out. Inert gas for controlling the atmosphere is introduced from a holding plate-receiving part of the lower part and discharged from a discharging port at the upper part of the heating part.

In FIG. 1, (2) is a heater; (3) is a high-frequency oscillating coil; and (6) is a heat insulating material.

Operating Procedure

The procedure shall be explained according to Fig.

A surrounding gas is allowed to flow.

The push-in plate is elevated up to the upper end.

The holding plate is raised to the position of A to inhibit the untreated carbon raw material (as grown) from leaking.

The fine carbon fiber material is introduced.

The carbon fibers are homogenized while moving the push-in plate up and down several times, and then the push-in plate is allowed to go down to the position of C to compress the above carbon fibers.

Driving is stopped in the above position for fixed time to heat the carbon fibers until they are soaked.

After completing the heat treatment, the holding plate is lowered to the position of B.

The push-in plate is lowered to the position of A while being pushed in.

The above carbon fibers which have finished treatment are discharged by a discharging plate.

The discharging plate is returned to the initial position.

The push-in plate is elevated up to the upper end.

The holding plate is raised to the position of A.

The cycle described above is repeated.

Operating Conditions and Results

Heating furnace temperature: 2800° C.

Soaking part length: 600 mm

Argon flow rate: 10 L/min

Raw material: carbon nanotube (as grown)

Charging amount: 1 kg/cycle

Heating time: 5 minute

Raw material d₀₀₂ (interplanar spacing)=0.369 nm d₀₀₂ after treated at 2800° C.: 0.339 nm

### Example 2

Continuous Process Equipment

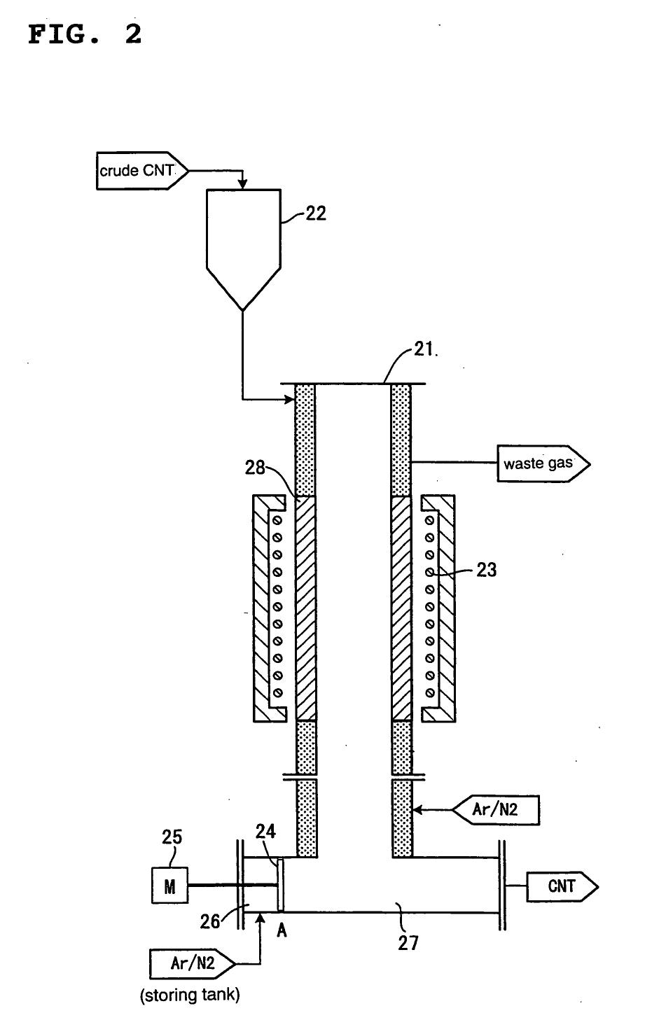

Carried out using equipment shown in FIG. 2.

It is a continuous system heating furnace having an inner diameter of 350 mmφ and a heating part length of 1250 mm, wherein it is equipped with a charging device (22) for charging as-grown fine carbon fibers which are compressed and then crushed and a waste gas-discharging device at the upper part, and the surrounding gas introduced from the lower part of the equipment is discharged from the waste gas-discharging device. Disposed at the lower part is a collecting device comprising a collecting part (27) for the above carbon fibers after subjected to heat treatment, a discharging plate (24) for the above powder subjected to heat treatment and a driving device (25) therefor. A surrounding gas-feeding device is present at a driving device side (26) of the discharging plate (24), and when the discharging plate is in the position of A, a pressure in the inside of a chamber on the side (26) is set up higher by 1 kPa than that of the heating furnace main body (21).

Operating Procedure and Conditions

The procedure shall be explained according to FIG. 2.

A surrounding gas is allowed to flow (superficial velocity: 10 mm/sec).

The furnace is heated (low temperature treatment: 900° C.).

The fine carbon fiber powder is introduced (residence time: 8 minutes and bulk density: 30 kg/m³).

The powder falling to (27) by virtue of gravity are discharged by the discharging plate (24). A cycle time of (24) is 30 seconds. Accordingly, a cycle time of pressure fluctuation given to the inside of the heating furnace is 30 seconds.

In FIG. 2, (23) represents a high-frequency coil, and (28) represents a heating part (furnace core) in the furnace.

Results

Comparison between before and after treatment was carried out by differential thermal analysis to find that volatile components were removed.

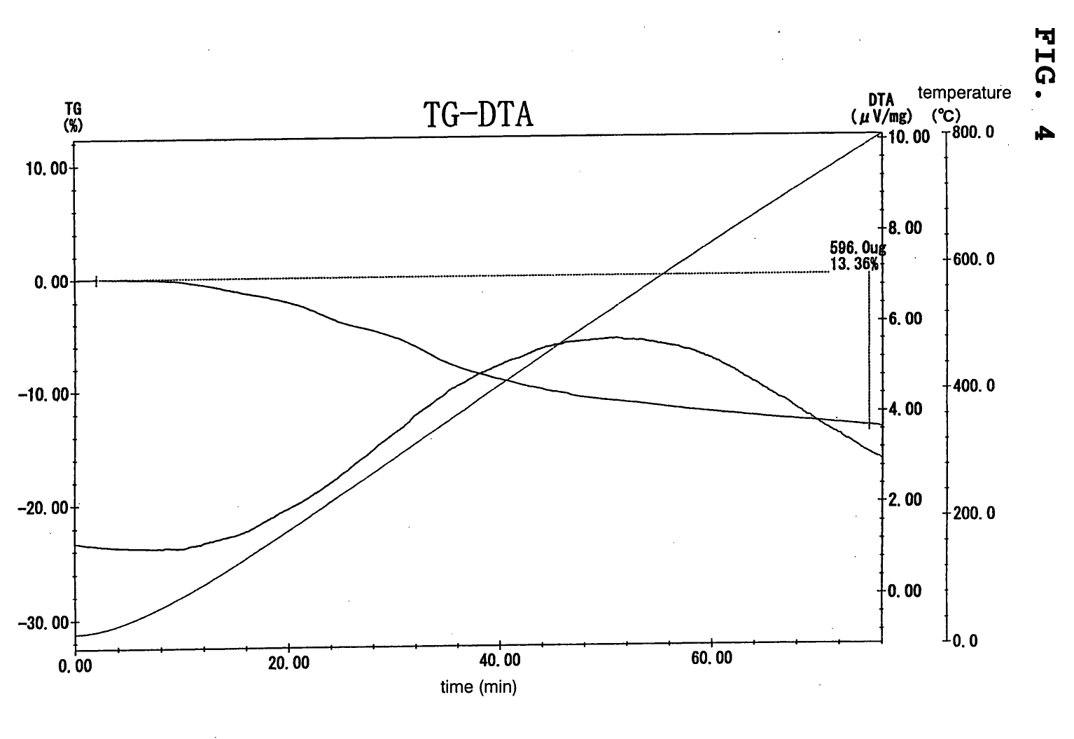

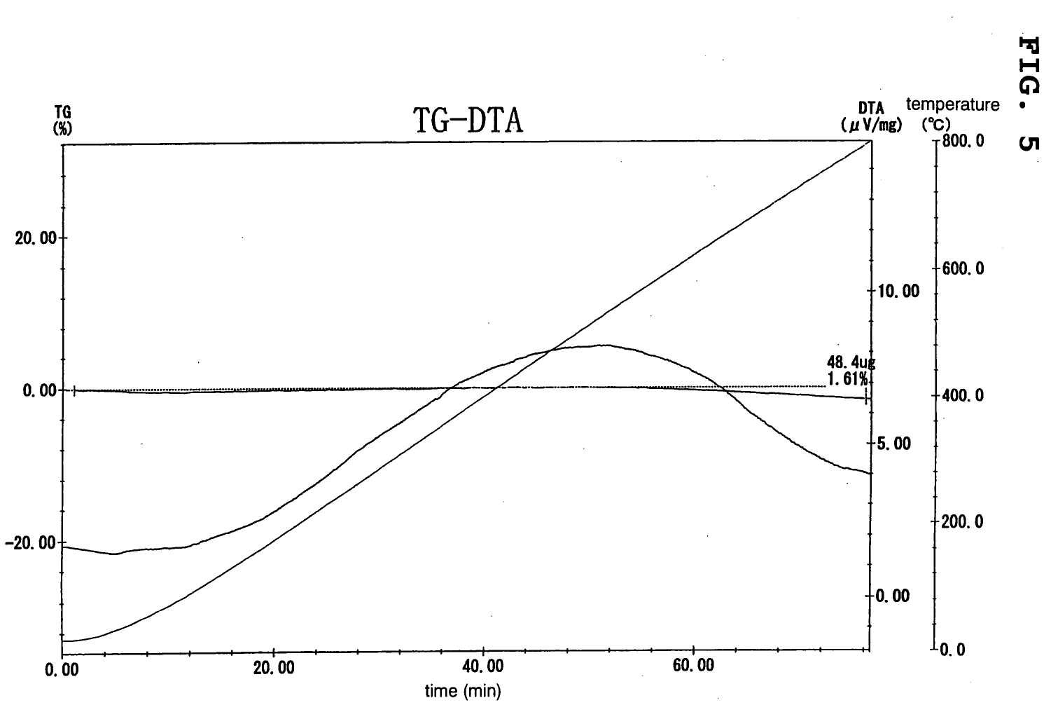

A differential thermal analytical chart of the fine carbon fibers before treatment is shown in FIG. 4, and a differential thermal analytical chart of the fine carbon fibers after treatment is shown in FIG. 5.

### Example 3

Semi-Batch/Continuous Process Equipment

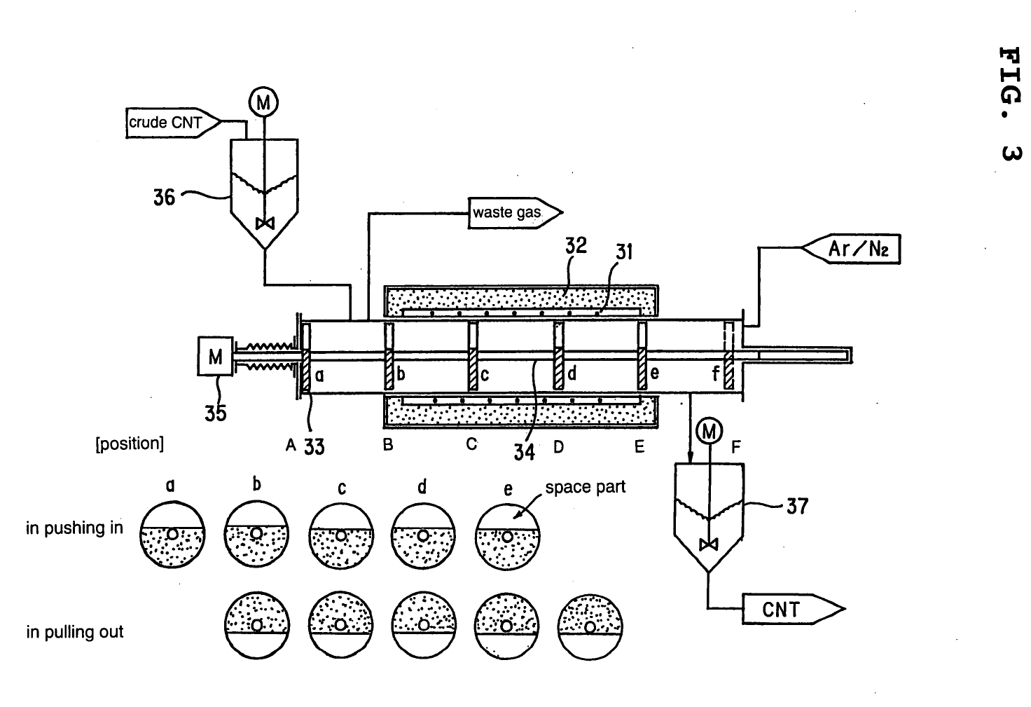

Carried out using equipment shown in FIG. 3.

It is a lateral batchwise heating furnace having an inner diameter of 200 mm, and push-in plates (33) are mounted on a movable shaft (34) disposed in a longitudinal direction of the furnace. This push-in plate has a notch part in a radius direction and assumes a structure in which it does not completely shut up a conduit. In the present example, a structure in which a segment of a circle is cut out has been assumed as shown in FIG. 3. The number of the push-in plates may be set up according to a push-in distance, and five plates of (a), (b), (c), (d) and (e) have been set in the present example. Further, the push-in plates are fixed on the movable shaft, and the fixing directions are set up so that the notch parts of the respective plates are overlapped when observing them along the shaft. The above movable shaft is prepared from a graphite material. The positions of the respective push-in plates in the axial direction may be disposed evenly or unevenly. The intervals may be different in the outside part of the soaking part. The plates have been disposed at an equal interval in the present example. The driving directions of the push-in plates are a direction in which the plates are reciprocated by a fixed distance along the shaft and a direction in which the shaft is rotated or reciprocated and rotated by a step motion of every 180 degrees, and they are driven by means of a driving device (35).

In FIG. 3, (31), (32) and (37) are a heater, a heat insulating material and a product collecting device respectively.

Operating Procedure

The procedure shall be explained according to FIG. 3.

A surrounding gas is allowed to flow, and the furnace is heated.

In starting the operation, the push-in plate (a) is placed in the position of A with the push-in part turned downward. In this case, the plate (e) is positioned at an end E of the heating part.

A raw material carbon nanotube (as grown) is charged from a raw material charging device (36) to a space between (a) and (b).

After charging a fixed amount of the above raw material, the push-in plate (a) is pushed in to the position of B.

In this case, five plates move at the same time, and the plate (e) comes to the position of F.

The plate is rotated by 180 degrees in the above position to replace the upper and lower parts of the plates (the plate is rotated by half round, and the upper and lower parts are replaced).

The push-in plate (a) is pulled back from the position of B to the position of A. The raw material is present between (b) and (c). The push-in plate is rotated by half round in the above position.

The raw material is charged to a space between (a) and (b).

After charging a fixed amount of the above raw material, the push-in plate (a) is pushed in to the position of B.

The push-in plate is rotated by half round in the above position.

The push-in plate (a) is pulled back from the position of B to the position of A. The raw material is present between (b) and (c) and between (c) and (d).

The push-in plate is rotated by half round in the above position.

The raw material is charged to a space between (a) and (b).

After charging a fixed amount of the above raw material, the push-in plate (a) is pushed in to the position of B.

The push-in plate is rotated by half round in the above position.

The push-in plate (a) is pulled back from the position of B to the position of A. The raw material is present between (b) and (c), between (c) and (d) and between (d) and (e).

The push-in plate is rotated by half round in the above position.

The raw material is charged to a space between (a) and (b).

After charging a fixed amount of the above raw material, the push-in plate (a) is pushed in to the position of B. In this case, the nanotubes present between (d) and (e) finish heat treatment and are transferred to a space between E and F, and therefore they are transferred to the collecting device.

The raw material powder charged from the charging port are pushed in to the downstream direction while subjected to heat treatment in order by repeating the above operation, and they are discharged from the end part.

Operating Conditions and Results

Heating furnace temperature: 2800° C.
Soaking part length: 600 mm
Argon flow rate: 10 L/min
Raw material: carbon nanotube (as grown)
Charging amount: 1 kg/5 minute
Raw material d₀₀₂: 0.370 nm
d₀₀₂ after treated at 2800° C.: 0.337 nm

### INDUSTRIAL APPLICABILITY

The fine carbon fiber produced by the process of the present invention has excellent characteristics such as electron emitting ability, hydrogen storage ability, electroconductivity and thermal conductivity, and it is used for various secondary batteries including a Li ion battery, fuel cells, FED, superconductive devices, semiconductors and electroconductive composite materials.

1-18. (canceled)

19. A powder heat treatment process characterized by subjecting fine carbon fibers to heat treatment at a temperature of 800° C. or higher under an inert gas atmosphere or a hydrogen gas atmosphere in the form of powder taken out from a reaction furnace for producing the fine carbon fibers without filling them into a specific vessel or compaction-molding them; and said process further characterized by comprising steps in which 1) volatile components stuck to the fine carbon fibers are vaporized at a temperature of 800 to 1500° C. and in which 2) they are then carbonized at a temperature of 1300 to 3000° C.

20. A powder heat treatment process characterized by subjecting fine carbon fibers to heat treatment at a temperature of 800° C. or higher under an inert gas atmosphere or a hydrogen gas atmosphere after compressing and crushing the fine carbon fibers to turn them into amorphous powder; and said process further characterized by comprising steps in which 1) volatile components stuck to the fine carbon fibers are vaporized at a temperature of 800 to 1500° C. and in which 2) they are then carbonized at a temperature of 1300 to 3000° C.

21. The powder heat treatment process as described in claim 20, wherein the powder after crushing has a bulk density of 15 to 35 kg/m³.

22. Powder heat treatment equipment characterized by installing a heating furnace for heating fine carbon fibers at a temperature of 800° C. or higher under an inert gas atmosphere or a hydrogen gas atmosphere in the form of powder taken out from a reaction furnace for producing the fine carbon fibers without filling them into a specific vessel or compaction-molding them, wherein the heating furnace is partitioned by push-in plates for the fine carbon fibers or stirring devices in the furnace; a surrounding gas-discharging port is provided in a part close to the charging port for the fine carbon fiber powder out of compartments partitioned by the above plates or devices; and the gas-feeding port is provided in a part close to the discharging port for the above powder, and wherein in the heating furnace, a gas storing tank for giving pressure fluctuation to the inside of the heating furnace is installed immediately before or immediately after the discharging port for the fine carbon fiber powder; said equipment further characterized by providing a surrounding gas-discharging port in a part close to a charging port for fine carbon fiber powder in a heating furnace and providing a surrounding gas-feeding port in a part close to a discharging port for the fine carbon fiber powder; said equipment further characterized by comprising an openable and closable valve or plate for giving pressure fluctuation to the heating furnace from the gas storing tank described above; and said equipment further characterized by installing a charging device for charging the fine carbon fiber to the heating furnace described above, a surrounding gas-feeding device for feeding an inert gas or a hydrogen gas to the heating furnace, a controlling device for controlling flow of the powder in the inside of the heating furnace, a collecting device for collecting the fine carbon fibers from the heating furnace and a trapping device for trapping carried components contained in a waste gas coming from the heating furnace.

23. Powder heat treatment equipment characterized by installing a heating furnace for heating fine carbon fibers at a temperature of 800° C. or higher under an inert gas atmosphere or a hydrogen gas atmosphere after compressing and crushing the fine carbon fibers to turn them into amorphous powder, wherein the heating furnace is partitioned by push-in plates for the fine carbon fibers or stirring devices in the furnace; a surrounding gas-discharging port is provided in a part close to the charging port for the fine carbon fiber powder out of compartments partitioned by the above plates or devices; and the gas-feeding port is provided in a part close to the discharging port for the above powder, and wherein in the heating furnace, a gas storing tank for giving pressure fluctuation to the inside of the heating furnace is installed immediately before or immediately after the discharging port for the fine carbon fiber powder; said equipment further characterized by providing a surrounding gas-discharging port in a part close to a charging port for fine carbon fiber powder in a heating furnace and providing a surrounding gas-feeding port in a part close to a discharging port for the fine carbon fiber powder; said equipment further characterized by comprising an openable and closable valve or plate for giving pressure fluctuation to the heating furnace from the gas storing tank described above; and said equipment further characterized by installing a charging device for charging the fine carbon fiber to the heating furnace described above, a surrounding gas-feeding device for feeding an inert gas or a hydrogen gas to the heating furnace, a controlling device for controlling flow of the powder in the inside of the heating furnace, a collecting device for collecting the fine carbon fibers from the heating furnace and a trapping device for trapping carried components contained in a waste gas coming from the heating furnace.

24. A powder heat treatment equipment, wherein it is installed a heating furnace for subjecting fine carbon fibers charged to heat treatment at a temperature of 800° C. or higher under an inert gas atmosphere or a hydrogen gas atmosphere; the heating furnace is a tube or cylinder extended to a prescribed direction; and the extended direction forms an angle of 0 degree or more to 90 degrees with a horizontal face.

25. The powder heat treatment equipment as described in claim 22, wherein the fine carbon fibers are continuously transferred in the inside of the heating furnace with flowing by virtue of gravity.

26. The powder heat treatment equipment as described in claim 23, wherein the fine carbon fibers are continuously transferred in the inside of the heating furnace with flowing by virtue of gravity.

27. The powder heat treatment equipment as described in claim 22, wherein the heating furnace described above is equipped with a push-in device driven by reciprocating motion for the fine carbon fibers and a shutting plate for the furnace.

28. The powder heat treatment equipment as described in claim 23, wherein the heating furnace described above is equipped with a push-in device driven by reciprocating motion for the fine carbon fibers and a shutting plate for the furnace.

29. The powder heat treatment equipment as described in claim 24, wherein the heating furnace described above is equipped with a push-in device driven by reciprocating motion for the fine carbon fibers and a shutting plate for the furnace.

30. The powder heat treatment equipment as described in claim 22, wherein the heating furnace described above is a lateral furnace which is horizontally or almost horizontally disposed; plural push-in plates which do not completely shut up the inner wall of the heating furnace are disposed on a driving shaft mounted so as to pass through the center of the furnace; and the driving shaft rotates and reciprocates in a horizontal direction, whereby the flow of the powder is controlled.

31. The powder heat treatment equipment as described in claim 23, wherein the heating furnace described above is a lateral furnace which is horizontally or almost horizontally disposed; plural push-in plates which do not completely shut up the inner wall of the heating furnace are disposed on a driving shaft mounted so as to pass through the center of the furnace; and the driving shaft rotates and reciprocates in a horizontal direction, whereby the flow of the powder is controlled.

32. The powder heat treatment equipment as described in claim 24, wherein the heating furnace described above is a lateral furnace which is horizontally or almost horizontally disposed; plural push-in plates which do not completely shut up the inner wall of the heating furnace are disposed on a driving shaft mounted so as to pass through the center of the furnace; and the driving shaft rotates and reciprocates in a horizontal direction, whereby the flow of the powder is controlled.

33. The powder heat treatment equipment as described in claim 30, wherein the fine carbon fibers are transferred semi-batchwise or continuously.

34. The powder heat treatment equipment as described in claim 31, wherein the fine carbon fibers are transferred semi-batchwise or continuously.

35. The powder heat treatment equipment as described in claim 32, wherein the fine carbon fibers are transferred semi-batchwise or continuously.

36. The powder heat treatment equipment as described in claim 33, wherein the fine carbon fibers to be subjected to heat treatment have an average diameter of 0.5 μm to 1 μm and an apparent density of 100 kg/m³ or less.

37. The powder heat treatment equipment as described in claim 34, wherein the fine carbon fibers to be subjected to heat treatment have an average diameter of 0.5 nm to 1 μm and an apparent density of 100 kg/m³ or less.

38. The powder heat treatment equipment as described in claim 35, wherein the fine carbon fibers to be subjected to heat treatment have an average diameter of 0.5 nm to 1 μm and an apparent density of 100 kg/m³ or less.

39. The powder heat treatment equipment as described in claim 36, wherein the fine carbon fibers to be subjected to heat treatment comprise single-walled carbon nanotubes and/or multiwalled carbon nanotubes in which the fibers have an average diameter of 0.5 nm to 1 μm and an apparent density of 100 kg/m³ or less.

40. The powder heat treatment equipment as described in claim 37, wherein the fine carbon fibers to be subjected to heat treatment comprise single-walled carbon nanotubes and/or multiwalled carbon nanotubes in which the fibers have an average diameter of 0.5 nm to 1 μm and an apparent density of 100 kg/m³ or less.

41. The powder heat treatment equipment as described in claim 38, wherein the fine carbon fibers to be subjected to heat treatment comprise single-walled carbon nanotubes and/or multiwalled carbon nanotubes in which the fibers have an average diameter of 0.5 nm to 1 μm and an apparent density of 100 kg/m³ or less.
